(19) United States
(12) Patent Application Publication
(10) Pub. No.: US 2026/0014674 A1
(43) Pub. Date: Jan. 15, 2026

(54) ANTI-SLIP WRENCH

(71) Applicant: CHIUNG JU CHEN, Taichung City (TW)

(72) Inventor: CHIUNG JU CHEN, Taichung City (TW)

(21) Appl. No.: 18/773,155

(22) Filed: Jul. 15, 2024

(51) Int. Cl. B25B 13/14; B25B 13/06; B25B 23/00

(52) U.S. Cl. CPC B25B 13/14; B25B 13/06; B25B 23/0014

(57) ABSTRACT

An anti-slip wrench has a handle. The handle has a first jaw and a second jaw. An upper portion of a first gripping surface of the first jaw has a first anti-slip surface. The first anti-slip surface has a plurality of first anti-slip teeth that are connected in sequence and extend laterally. The first anti-slip teeth each have a back face and a front face. The angle between the back face and a tooth profile reference line is defined as a tooth back inclination. The second jaw has a second gripping surface. An upper portion of the second gripping surface has a second anti-slip surface. The second anti-slip surface has a plurality of second anti-slip teeth that are connected in sequence and extend laterally. The second anti-slip teeth are oriented in a direction opposite to that of the first anti-slip teeth.

### FIELD OF THE INVENTION

The present invention relates to an anti-slip wrench for turning a bolt or nut. When in use, the corners on the sides of the bolt or nut won't be worn easily.

### BACKGROUND OF THE INVENTION

A wrench is a hand tool that uses the principle of leverage to grip and turn bolts, nuts, and other fasteners that are difficult to turn by hand. In general, a wrench has a jaw opening at either or both ends of the handle for gripping a fastener. When in use, the user applies an external force at the other end of the handle in the direction of rotation to turn the fastener. Because the jaw opening is configured to grip a fastener, its size is slightly larger than the fastener so there are gaps between the two gripped sides of the fastener and the jaw opening. The gaps may cause wear on the corners of the gripped sides of the fastener when the wrench is turned.

For example, as shown in FIG. 1, FIG. 2, and FIG. 3, an adjustable wrench consists of a handle 10, a fixed jaw 20, and a movable jaw 30. The fixed jaw 20 is integrally formed with the top of the handle 10. A rotatable worm 40 is transversely provided. The movable jaw 30 is movably disposed on the top of the handle 10 and can be moved closer to or away from the fixed jaw 20 to adjust the distance between the movable jaw 30 and the fixed jaw 20. Further, the bottom of the movable jaw 30 has a rack 31 meshing with the worm 40. This allows the user to adjust the distance W1 between the movable jaw 30 and the fixed jaw 20 by rotating the worm 40, thereby gripping a retained fastener 50 such as a nut or bolt for tightening or loosening operations. The distance W1 is greater than the width W2 defined between the two gripped sides of the fastener 50 so there are gaps S1, S2, as shown in FIG. 3, FIG. 4, and FIG. 5. When the wrench is used to turn the fastener 50, the clearance (fit tolerance) between the rack 31 of the movable jaw 30 and the worm 40 will increase the distance W1. When the fixed jaw 20 and the movable jaw 30 grip the opposite sides of the fastener 50, the corners 51 on the gripped sides of the fastener 50 will bear the force from the fixed jaw 20 and the movable jaw 30 in a linear contact manner, which may lead to wear on the corners 51 due to slippage. When the fastener 50 is turned frequently, as shown in FIG. 6, the corners 51 of the fastener 50A will suffer a lot of worn. This will affect the operations of the wrench.

### SUMMARY OF THE INVENTION

The primary object of the present invention is to provide an anti-slip wrench. The anti-slip wrench has a handle. A first jaw head is formed on at least one end of the handle. The first jaw head includes a first jaw and a second jaw. A surface of the first jaw, facing the second jaw, is defined as a first gripping surface. The upper portion of the first gripping surface has a first anti-slip surface. The first anti-slip surface has a plurality of first anti-slip teeth that are connected in sequence and extend laterally. The first anti-slip teeth each have a tip. The distance between the tips of every adjacent two of the first anti-slip teeth is defined as a tooth pitch. The tips of the first anti-slip teeth are aligned with the first gripping surface. A line extending along the tips of the first anti-slip teeth is defined as a gripping alignment line. A line perpendicular to the gripping alignment line at the tip is defined as a tooth profile reference line. The first anti-slip teeth each have a root. A line extending along the roots of the first anti-slip teeth is defined as a root line. The root line is parallel to the gripping alignment line. The distance between the gripping alignment line and the root line is defined as a tooth height. The tooth pitch is 0.5 mm to 2 mm, which is 1.5 to 2.5 times the tooth height. The first anti-slip teeth each have a back face extending and inclining outwardly from the tip to the root line and a front face extending and inclining inwardly from the tip to the root line. The angle between the back face and the tooth profile reference line is defined as a tooth back inclination. The angle between the front face and the tooth profile reference line is defined as a tooth height inclination. The tooth back inclination is 3.5 to 5.5 times the tooth height inclination. The second jaw has a second gripping surface corresponding to the first jaw. A jaw opening is defined between second gripping surface and the first clamping surface. The upper portion of the second gripping surface has a second anti-slip surface. The second anti-slip surface has a plurality of second anti-slip teeth that are connected in sequence and extend laterally. The second anti-slip teeth are oriented in a direction opposite to that of the first anti-slip teeth.

When in use, the first gripping surface and the second gripping surface of the first jaw and the second jaw grip two corresponding sides of a hexagonal bolt or nut (hereinafter referred to as a fastener). The width of the jaw opening is slightly larger than the width of the two sides of the fastener so there are gaps. When the user holds the handle of the wrench and operates the first jaw head to turn the fastener, the corner of the fastener will be received in the tooth gap between two of the first anti-slip teeth and/or the second anti-slip teeth of the first anti-slip surface and/or the second anti-slip surface. That is, the tips of two of the first anti-slip teeth and/or the second anti-slip teeth 53 are against the side of the fastener and the corner of the fastener is against the back face, thereby forming multi-point support and torque to turn the fastener. The first anti-slip surface and the second anti-slip surface can hold the corners of the fastener to prevent slipping, so that the fastener can be turned by the wrench repeatedly and the corners of the fastener are not easily worn.

Preferably, the tooth height of the first anti-slip teeth is greater than 0.2 mm and less than 1 mm, which ensures the ability of the first anti-slip teeth and/or the second anti-slip teeth to hold the corner of the fastener. The angle of the tooth back inclination is not too small, so as to prevent the back face from leaving the corner of the fastener. The angle between the tooth back inclination and the tooth profile reference line is greater than 50 degrees and less than 75 degrees, so that the corner of the fastener is supported on the back face effectively. The tooth height is 0.5 mm. The tooth pitch is 0.75 mm to 1.2 mm. The tooth back inclination is 55 degrees to 65 degrees. The gap between the jaw opening and the fastener may vary slightly, which also has a good anti-slip effect on the corner of the fastener.

Preferably, the first anti-slip surface and the second anti-slip surface are two-fifths to three-fifths of the first gripping surface and the second gripping surface, respectively. The first anti-slip surface and the second anti-slip surface occupy less than the entire area of the first gripping surface and the second gripping surface. The first gripping surface and the second gripping surface are configured for gripping the fastener, providing an anti-slip function of holding the corners of the fastener. That is, the fastener is fully in the jaw opening during the initial or final turning of the fastener.

Preferably, a guide groove is formed on a front end face of the first jaw head. A worm groove is defined in the jaw head. The worm groove is tangent to the guide groove. A rotatable worm is pivotally connected in the worm groove. The first jaw is assembled on the guide groove and has a rack meshing with the worm. The second jaw faces the first jaw and is integrally formed with the first jaw head. The rotation of the worm can drive the first jaw to slide on the guide groove. According to the specification of the fastener, the worm is operated to move the first gripping surface to be closer to or away from the second gripping surface, thereby controlling or determining the jaw opening. A second jaw head is provided at the other end of the handle opposite the first jaw head. The second jaw head is horseshoe-shaped and has a U-shaped notch. A socket connector is pivotally connected to the U-shaped notch. One end of the socket connector has a pivot portion that is pivotally connected to the U-shaped notch 81. The other end of the socket connector has a socket connecting portion. The socket connector is pivoted on the second jaw head, and a hexagonal socket is connected to the socket connecting portion so that the wrench can be used as a socket wrench.

Alternatively, the first jaw and the second jaw may be in the form of a pair of fixed jaws that are integrally formed with the first jaw head and extend outwardly, such that the wrench may be used as an open-end wrench. A second jaw head is provided at the other end of the handle opposite the first jaw head. The second jaw head includes a third jaw and a fourth jaw that are fixed jaws and integrally formed with the second jaw head and extend outwardly and have the same configuration as the first jaw and the second jaw. The jaw opening of the second jaw head and the jaw opening of the first jaw head are different in size, so that the wrench may be used as a double-ended open-end wrench.

### BRIEF DESCRIPTION OF THE DRAWINGS

FIG. 1 is a perspective view of a conventional adjustable wrench;

FIG. 2 is a schematic view of the conventional adjustable wrench, wherein a fastener is gripped by the conventional adjustable wrench;

FIG. 3 is an enlarged view of circle A in FIG. 2;

FIG. 4 is a schematic view of the conventional adjustable wrench, wherein the fastener is turned by the conventional adjustable wrench;

FIG. 5 is an enlarged view of circle B in FIG. 4;

FIG. 6 is a schematic view of the conventional adjustable wrench, wherein the corners of the fastener suffer a lot of worn;

FIG. 7 is an exploded view of the present invention;

FIG. 8 is a perspective view of the present invention;

FIG. 9 is a planar view of the present invention;

FIG. 10 is an enlarged view of circle C in FIG. 9;

FIG. 11 is an enlarged view of circle D in FIG. 10;

FIG. 12 is a schematic view of the present invention, wherein a fastener is gripped and turned by the wrench;

FIG. 13 is an enlarged view of circle E in FIG. 12;

FIG. 14 is an enlarged view of circle F in FIG. 12;

FIG. 15 is a perspective view of the present invention connected with a socket;

FIG. 16 is a perspective view of another embodiment of the present invention; and

FIG. 17 is a planar view of another embodiment of the present invention.

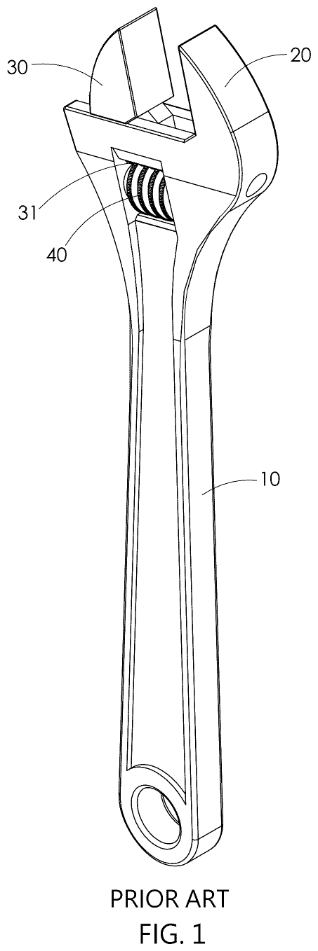

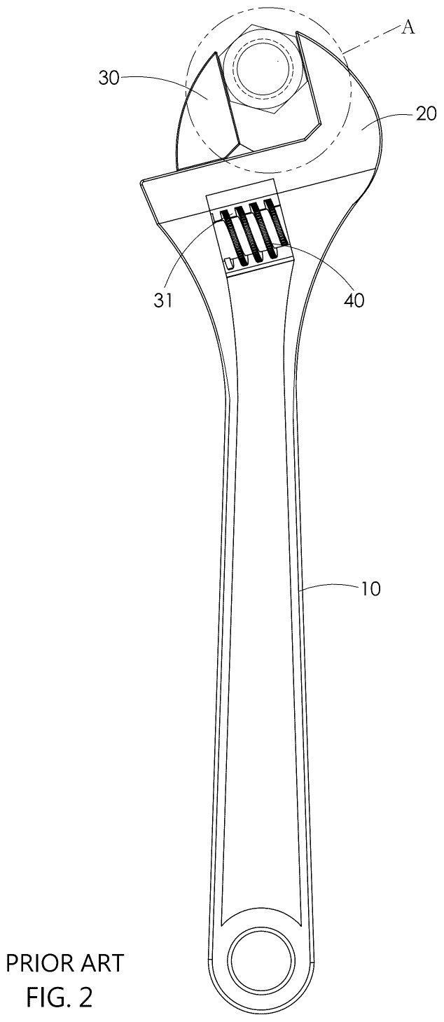

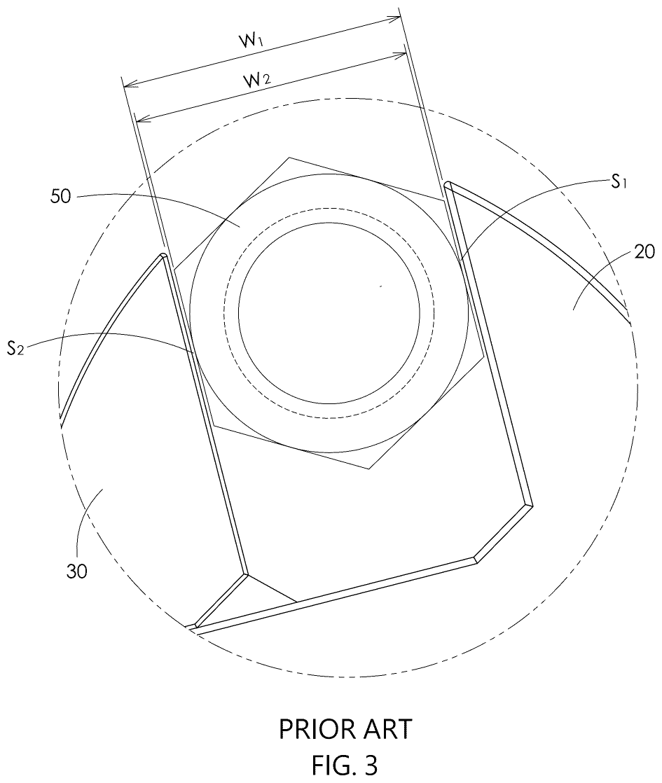

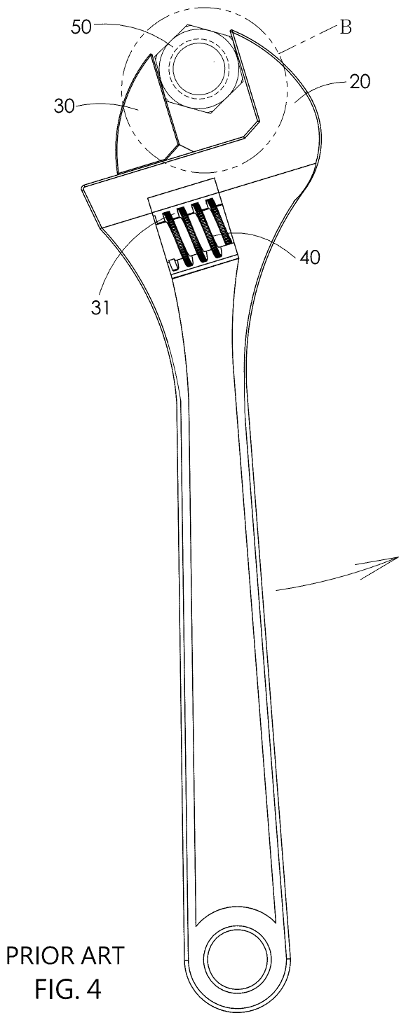

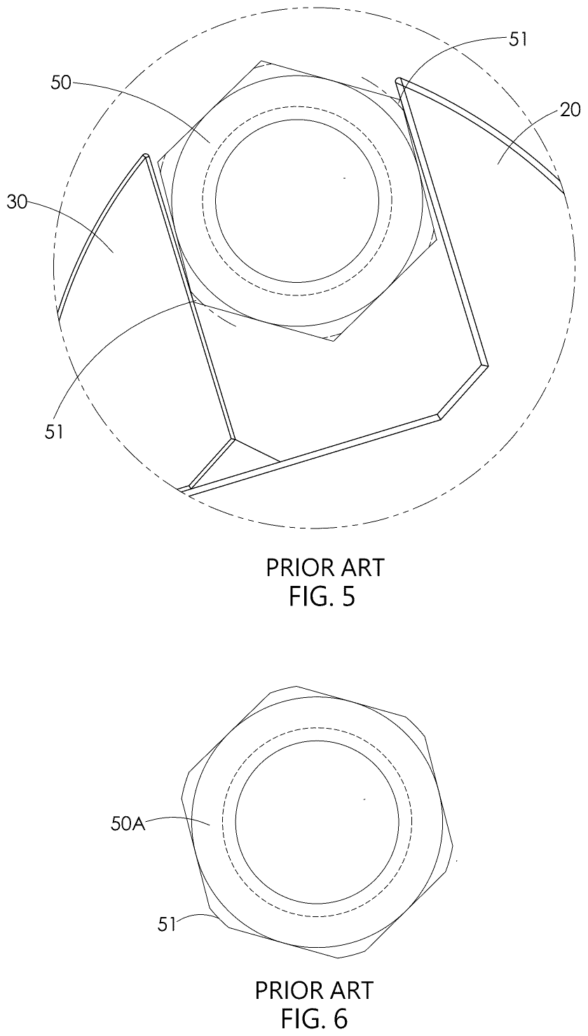

### DETAILED DESCRIPTION OF THE PREFERRED EMBODIMENTS

Embodiments of the present invention will now be described, by way of example only, with reference to the accompanying drawings.

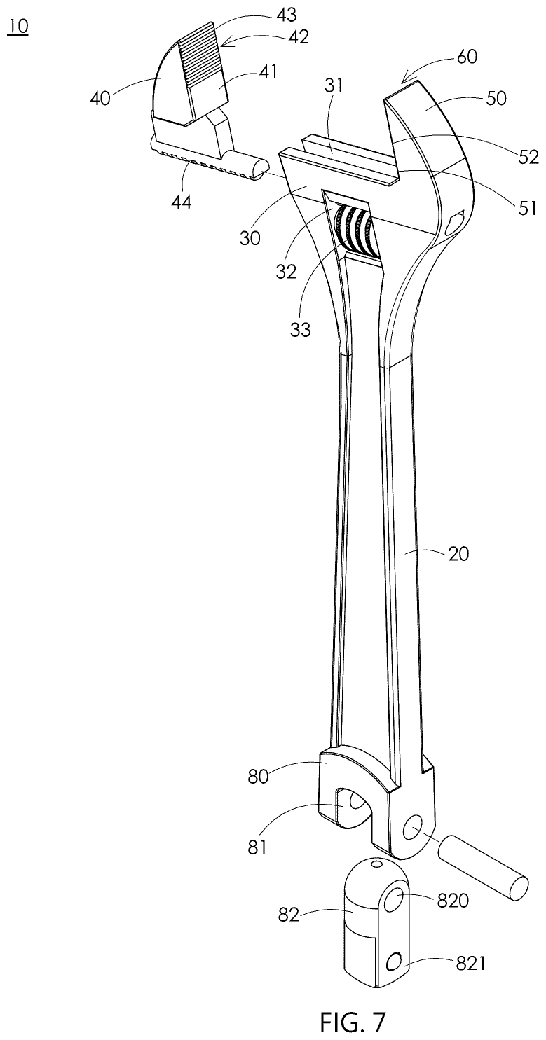

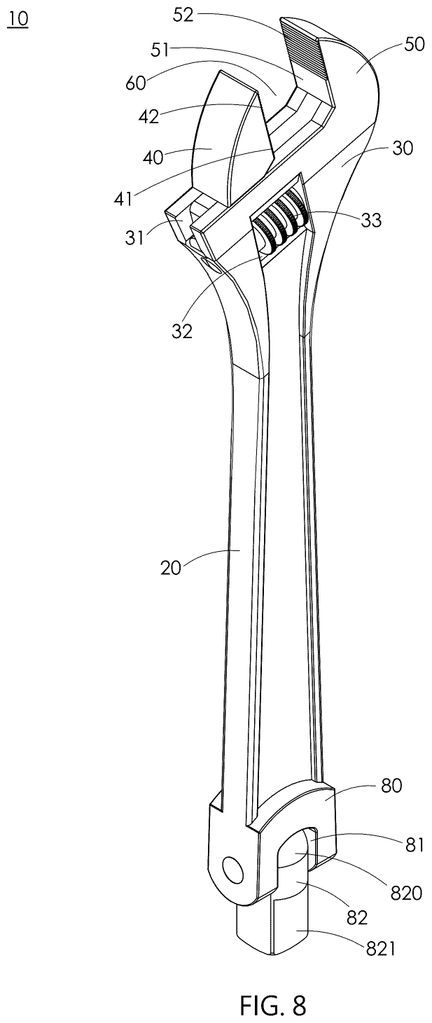

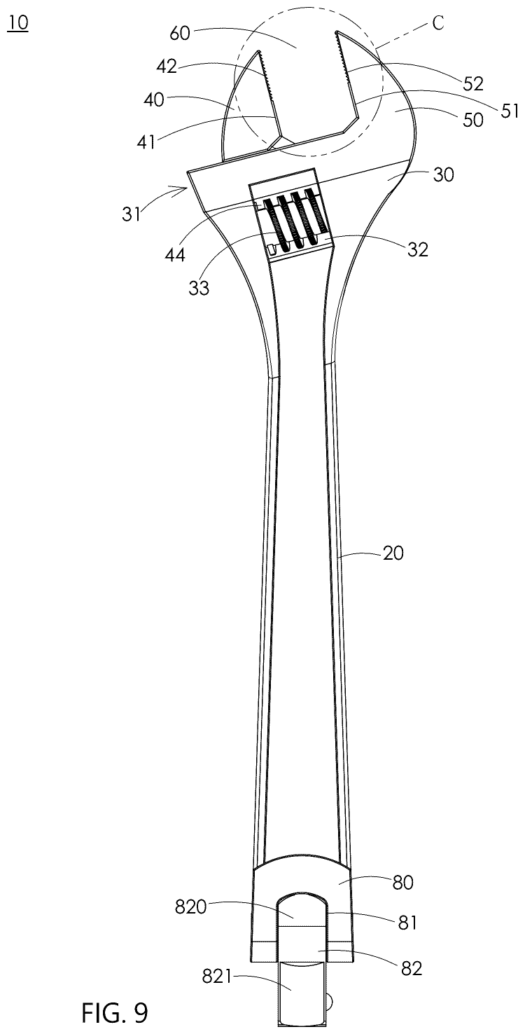

An anti-slip wrench 10, as shown in FIGS. 7 to 11, has a handle 20. A first jaw head 30 is formed on at least one end of the handle 20. The first jaw head 30 includes a first jaw 40 and a second jaw 50. A surface of the first jaw 40, facing the second jaw 50, is defined as a first gripping surface 41. The upper portion of the first gripping surface 41 has a first anti-slip surface 42. The first anti-slip surface 42 has a plurality of first anti-slip teeth 43 that are connected in sequence and extend laterally. The first anti-slip teeth 43 each have a tip 430. The distance between the tips 430 of every adjacent two of the first anti-slip teeth 43 is defined as a tooth pitch D. The tips 430 of the first anti-slip teeth 43 are aligned with the first gripping surface 41. A line extending along the tips 430 of the first anti-slip teeth 43 is defined as a gripping alignment line B₁. A line perpendicular to the gripping alignment line B₁ at the tip 430 is defined as a tooth profile reference line B₂. The first anti-slip teeth 43 each have a root. A line extending along the roots of the first anti-slip teeth 43 is defined as a root line B₃. The root line B₃ is parallel to the gripping alignment line B₁. The distance between the gripping alignment line B₁ and the root line B₃ is defined as a tooth height H. The tooth pitch D is 0.5 mm to 2 mm, which is 1.5 to 2.5 times the tooth height H. The first anti-slip teeth 43 each have a back face 431 extending and inclining outwardly from the tip 430 to the root line B₃ and a front face 432 extending and inclining inwardly from the tip 430 to the root line B₃. The angle between the back face 431 and the tooth profile reference line B₂ is defined as a tooth back inclination α. The angle between the front face 432 and the tooth profile reference line B₂ is defined as a tooth height inclination β. The tooth back inclination α is 3.5 to 5.5 times the tooth height inclination β. The second jaw 50 has a second gripping surface 51 corresponding to the first jaw 40. A jaw opening 60 is defined between second gripping surface 51 and the first clamping surface 41. The upper portion of the second gripping surface 51 has a second anti-slip surface 52. The second anti-slip surface 52 has a plurality of second anti-slip teeth 53 that are connected in sequence and extend laterally. The second anti-slip teeth 53 are oriented in a direction opposite to that of the first anti-slip teeth 43.

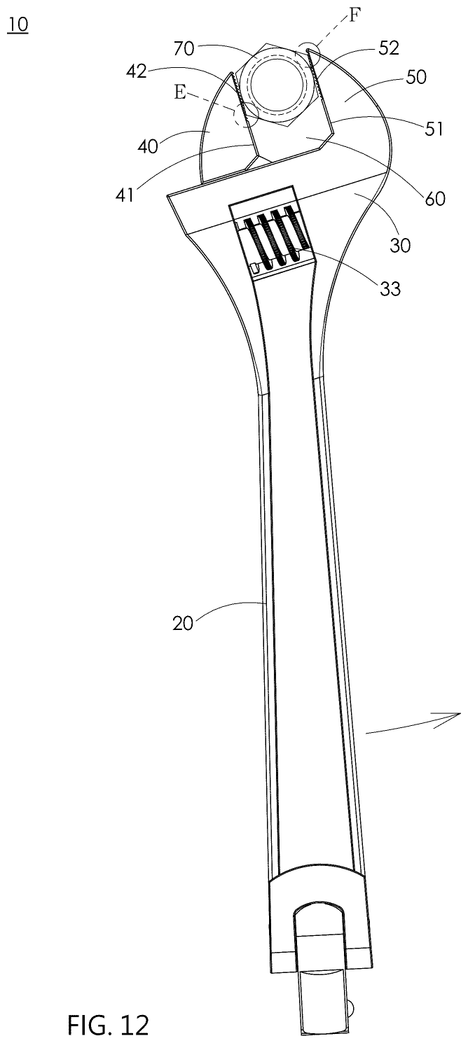

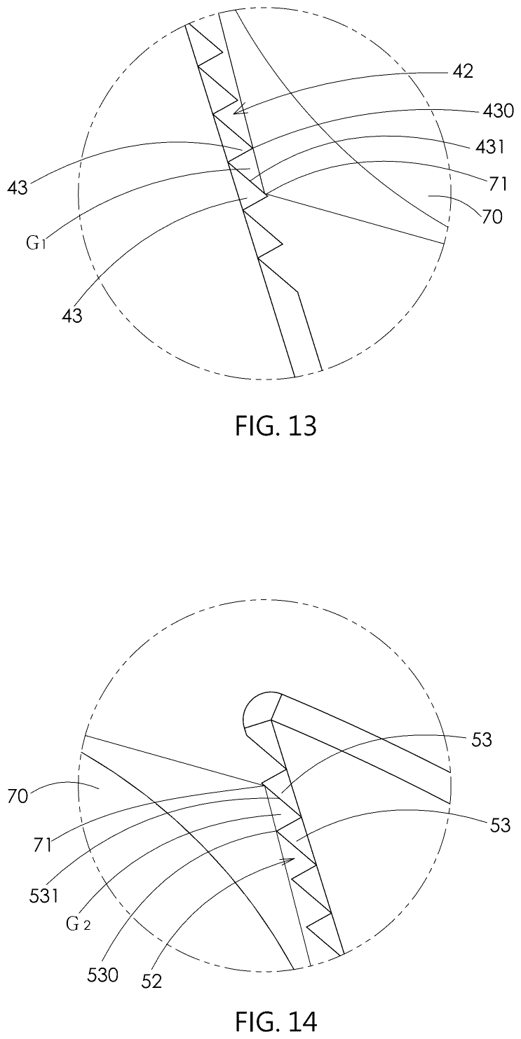

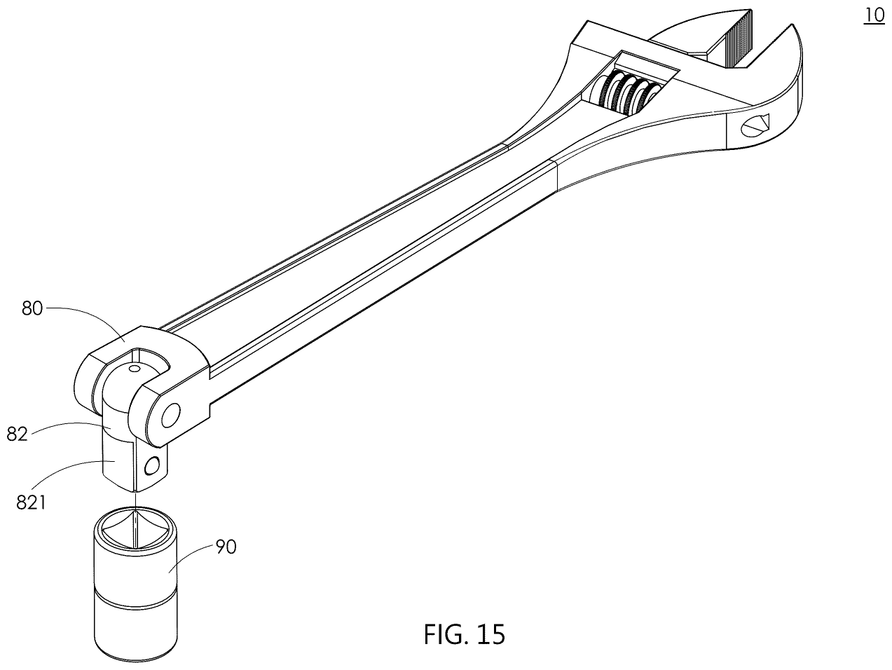

When in use, as shown in FIG. 12, the first gripping surface 41 and the second gripping surface 51 of the first jaw 40 and the second jaw 50 grip two corresponding sides of a hexagonal bolt or nut (hereinafter referred to as a fastener 70). The width of the jaw opening 60 is slightly larger than the width of the two sides of the fastener 70 so there are gaps. As shown in the figures of this embodiment, the fastener is turned counterclockwise. If the fastener is to be turned clockwise, the wrench is operated reversely, which will not be described again here. When the user holds the handle 20 of the wrench 10 and operates the first jaw head 30 to turn the fastener 70 counterclockwise, as shown in FIG. 13 and FIG. 14, the corner 71 of the fastener 70 will be received in the tooth gap G1/G2 between two of the first anti-slip teeth 43 and/or the second anti-slip teeth 53 of the first anti-slip surface 42 and/or the second anti-slip surface 52. That is, the tips 430/530 of two of the first anti-slip teeth 43 and/or the second anti-slip teeth 53 are against the side of the fastener 70 and the corner 71 of the fastener 70 is against the back face 431, 531, thereby forming multi-point support and torque to turn the fastener 70. The first anti-slip surface 42 and the second anti-slip surface 52 can hold the corners 71 of the fastener 70 to prevent slipping, so that the fastener 70 can be turned by the wrench 10 repeatedly and the corners 71 of the fastener 70 are not easily worn.

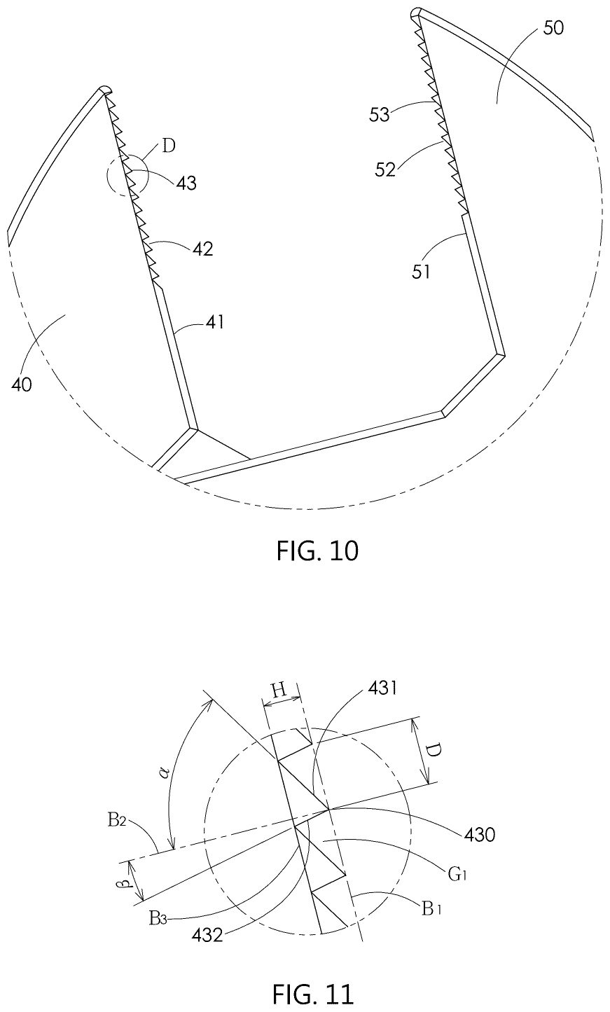

According to the above embodiment, preferably, as shown in FIG. 10 and FIG. 11, the tooth height H of the first anti-slip teeth 43 is greater than 0.2 mm and less than 1 mm, as shown in FIG. 13 and FIG. 14, which ensures the ability of the first anti-slip teeth 43 and/or the second anti-slip teeth 53 to hold the corner 71 of the fastener 70. The angle of the tooth back inclination α is not too small (referring to FIG. 11), so as to prevent the back face 431, 531 from leaving the corner 71 of the fastener 70. As shown in FIG. 11, the angle between the tooth back inclination α and the tooth profile reference line B₂ is greater than 50 degrees and less than 75 degrees, so that the corner 71 of the fastener 70 is supported on the back face 431, 531 effectively. As shown in FIG. 11, the tooth height His 0.5 mm. The tooth pitch Dis 0.75 mm to 1.2 mm. The tooth back inclination α is 55 degrees to 65 degrees. As shown in FIG. 12, FIG. 13, and FIG. 14, the gap between the jaw opening 60 and the fastener 70 may vary slightly, which also has a good anti-slip effect on the corner 71 of the fastener 70.

According to the above embodiment, preferably, as shown in FIGS. 7-10, the first anti-slip surface 42 and the second anti-slip surface 52 are two-fifths to three-fifths of the first gripping surface 41 and the second gripping surface 51, respectively. The first anti-slip surface 42 and the second anti-slip surface 52 occupy less than the entire area of the first gripping surface 41 and the second gripping surface 51. As shown in FIG. 12, the first gripping surface 41 and the second gripping surface 51 are configured for gripping the fastener 70, providing an anti-slip function of holding the corners 71 of the fastener 70. That is, the fastener 70 is fully in the jaw opening 60 (not shown in the figure) during the initial or final turning of the fastener 70.

According to the above embodiment, preferably, as shown in FIGS. 7-9, a guide groove 31 is formed on a front end face of the first jaw head 30. A worm groove 32 is defined in the jaw head 30. The worm groove 32 is tangent to the guide groove 31. A rotatable worm 33 is pivotally connected in the worm groove 32. The first jaw 40 is assembled on the guide groove 31 and has a rack 44 meshing with the worm 33. The second jaw 50 faces the first jaw 40 and is integrally formed with the first jaw head 30. The rotation of the worm 33 can drive the first jaw 40 to slide on the guide groove 31. As shown in FIG. 12, according to the specification of the fastener 70, the worm 33 is operated to move the first gripping surface 41 to be closer to or away from the second gripping surface 51, thereby controlling or determining the jaw opening 60.

As shown in FIGS. 7-9, a second jaw head 80 is provided at the other end of the handle 20 opposite the first jaw head 30. The second jaw head 80 is horseshoe-shaped and has a U-shaped notch 81. A socket connector 82 is pivotally connected to the U-shaped notch 81. One end of the socket connector 82 has a pivot portion 820 that is pivotally connected to the U-shaped notch 81. The other end of the socket connector 82 has a socket connecting portion 821. As shown in FIG. 15, the socket connector 82 can be pivoted on the second jaw head 80, and a hexagonal socket 90 is connected to the socket connecting portion 821 so that the wrench 10 can be used as a socket wrench.

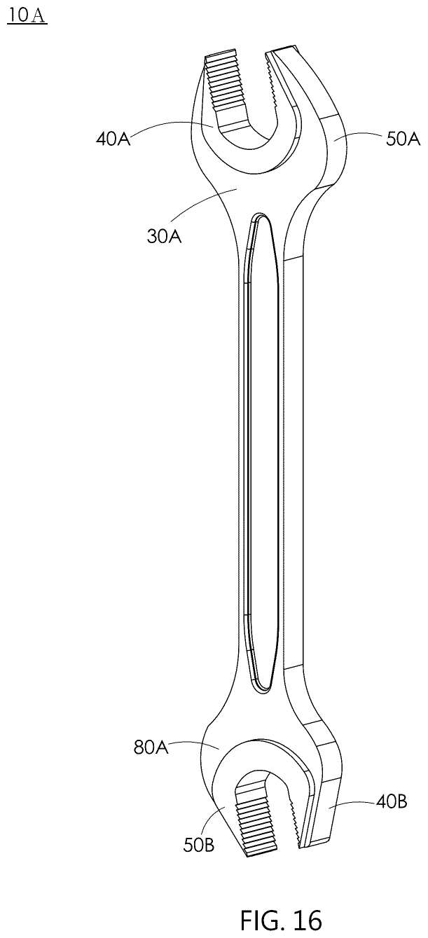

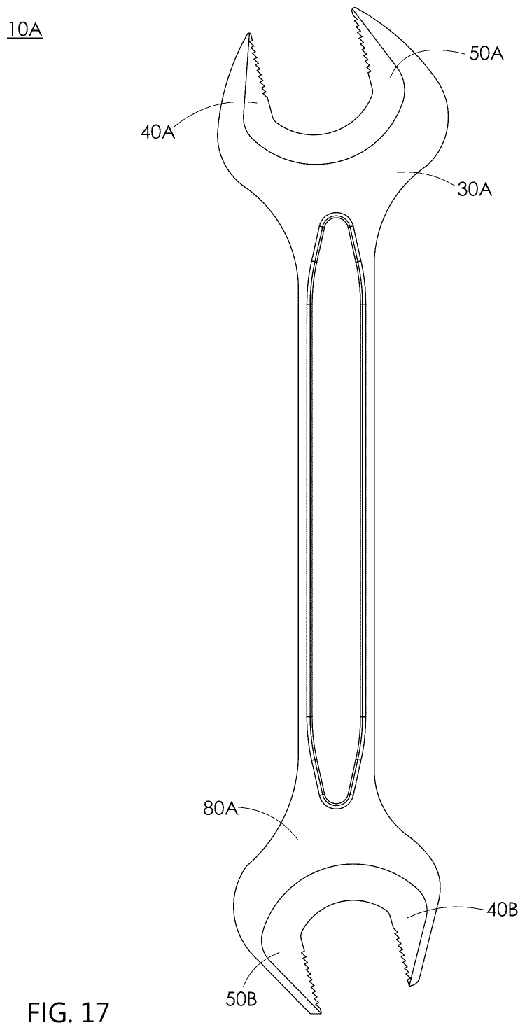

According to the above embodiment, preferably, as shown in FIG. 16 and FIG. 17, the first jaw 40A and the second jaw 50A are in the form of a pair of fixed jaws that are integrally formed with the first jaw head 30A and extend outwardly, such that the wrench 10A may be used as an open-end wrench. A second jaw head 80A is provided at the other end of the handle 20 opposite the first jaw head 30A. The second jaw head 80A includes a third jaw 40B and a fourth jaw 50B that are fixed jaws and integrally formed with the second jaw head 80A and extend outwardly and have the same configuration as the first jaw 40A and the second jaw 50A. The jaw opening of the second jaw head 80A and the jaw opening of the first jaw head 30A are different in size, so that the wrench 10A may be used as a double-ended open-end wrench.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An anti-slip wrench, having a handle, a first jaw head being formed on at least one end of the handle, the first jaw head including a first jaw and a second jaw; a surface of the first jaw, facing the second jaw, being defined as a first gripping surface, an upper portion of the first gripping surface having a first anti-slip surface, the first anti-slip surface having a plurality of first anti-slip teeth that are connected in sequence and extend laterally, the first anti-slip teeth each having a tip, a distance between the tips of every adjacent two of the first anti-slip teeth being defined as a tooth pitch, the tips of the first anti-slip teeth being aligned with the first gripping surface, a line extending along the tips of the first anti-slip teeth being defined as a gripping alignment line, a line perpendicular to the gripping alignment line at the tip being defined as a tooth profile reference line, the first anti-slip teeth each having a root, a line extending along the roots of the first anti-slip teeth being defined as a root line, the root line being parallel to the gripping alignment line, a distance between the gripping alignment line and the root line being defined as a tooth height, the tooth pitch being 0.5 mm to 2 mm and being 1.5 to 2.5 times the tooth height, the first anti-slip teeth each having a back face extending and inclining outwardly from the tip to the root line and a front face extending and inclining inwardly from the tip to the root line, an angle between the back face and the tooth profile reference line being defined as a tooth back inclination, an angle between the front face and the tooth profile reference line being defined as a tooth height inclination, the tooth back inclination being 3.5 to 5.5 times the tooth height inclination; the second jaw having a second gripping surface corresponding to the first jaw, a jaw opening being defined between second gripping surface and the first clamping surface, an upper portion of the second gripping surface having a second anti-slip surface, the second anti-slip surface having a plurality of second anti-slip teeth that are connected in sequence and extend laterally, the second anti-slip teeth being oriented in a direction opposite to that of the first anti-slip teeth.

2. The anti-slip wrench as claimed in claim 1, wherein the tooth height of the first anti-slip teeth is greater than 0.2 mm and less than 1 mm.

3. The anti-slip wrench as claimed in claim 2, wherein an angle between the tooth back inclination and the tooth profile reference line is greater than 50 degrees and less than 75 degrees.

4. The anti-slip wrench as claimed in claim 3, wherein the tooth height is 0.5 mm, the tooth pitch is 0.75 mm to 1.2 mm, and the tooth back inclination α is 55 degrees to 65 degrees.

5. The anti-slip wrench as claimed in claim 1, wherein the first anti-slip surface and the second anti-slip surface are two-fifths to three-fifths of the first gripping surface and the second gripping surface, respectively.

6. The anti-slip wrench as claimed in claim 1, wherein a guide groove is formed on a front end face of the first jaw head, a worm groove is defined in the jaw head, the worm groove is tangent to the guide groove, a rotatable worm is pivotally connected in the worm groove, the first jaw is assembled on the guide groove and has a rack meshing with the worm, the second jaw faces the first jaw and is integrally formed with the first jaw head.

7. The anti-slip wrench as claimed in claim 6, wherein a second jaw head is provided at another end of the handle opposite the first jaw head, the second jaw head is horseshoe-shaped and has a U-shaped notch, a socket connector is pivotally connected to the U-shaped notch, one end of the socket connector has a pivot portion that is pivotally connected to the U-shaped notch, and another end of the socket connector has a socket connecting portion.

8. The anti-slip wrench as claimed in claim 1, wherein the first jaw and the second jaw are in the form of a pair of fixed jaws that are integrally formed with the first jaw head and extend outwardly.

9. The anti-slip wrench as claimed in claim 8, wherein a second jaw head is provided at another end of the handle opposite the first jaw head, the second jaw head includes a third jaw and a fourth jaw that are fixed jaws and integrally formed with the second jaw head and extend outwardly and have a same configuration as the first jaw and the second jaw.
